(19) United States
(12) Patent Application Publication
(10) Pub. No.: US 2015/0362356 A1
(43) Pub. Date: Dec. 17, 2015

(54) FLUID LEVEL SENSOR

(71) Applicant: YAZAKI CORPORATION, Tokyo (JP)

(72) Inventors: Toshiaki Fukuhara, Shizuoka (JP); Shinpei Kato, Shizuoka (JP); Ryo Hirose, Shizuoka (JP)

(21) Appl. No.: 14/835,050

(22) Filed: Aug. 25, 2015

Related U.S. Application Data
(63) Continuation of application No. PCT/JP2014/054548, filed on Feb. 25, 2014.

(30) Foreign Application Priority Data
Feb. 27, 2013 (JP) 2013-036964

(51) Int. Cl. G01F 23/36

(52) U.S. Cl. CPC G01F 23/36

(57) ABSTRACT

A sensor housing of a fluid level sensor includes a peripheral wall portion and a lead wire inserting portion. The peripheral wall portion forms a hollow space penetrating in the depth direction of the sensor housing and is formed in a manner of surrounding the periphery of a terminal area of a lead frame. The lead wire inserting portion is formed by notching the peripheral wall portion in the depth direction of the sensor housing. The lead wire inserting portion consists of a first inserting portion into which a lead wire extending from the terminal area is inserted and a second inserting portion into which the lead wire is inserted after passing through the first inserting portion and holds the lead wire in a manner of bending the lead wire in a crank shape. With this configuration, the fluid level sensor can prevent leak current generated on the terminal area and thus can connect a conductive wire (the lead wire) used for connection with an external circuit with the terminal area in good condition.

### CROSS-REFERENCE TO RELATED APPLICATION

This application is a continuation application of International Application PCT/JP2014/054548, filed on Feb. 25, 2014, and designating the U.S., the entire contents of which are incorporated herein by reference.

### BACKGROUND OF THE INVENTION

1. Field of the Invention

The present invention relates to a fluid level sensor.

2. Description of the Related Art

Fluid level sensors for detecting a fluid level are conventionally known and used, for example, for detecting the height of a fluid surface of fuel stored in a fuel tank of a car. Such fluid level sensors rotate a circular magnet rotatably provided to a sensor housing by using behavior of a float moving up and down with displacement of a fluid level to be measured and detect a change of the magnetic flux density generated around the magnet with a detection circuit arranged in the sensor housing.

For example, Japanese Laid-open Patent Publication No. 2010-2253 describes a fluid level sensor having a resistor board forming thereon a conductive pattern with a pair of electrodes. This fluid level sensor outputs the potential difference generated between electrodes to an external circuit through a conductive wire and includes a connecting terminal connecting between an electrode and the conductive wire.

The method described in Japanese Laid-open Patent Publication No. 2010-2253, however, problematically causes leak current at a connection terminal in conductive fuel such as ethanol and ethanol-blended gasoline fuel and increases contact resistance due to, for example, corrosion of the connection terminal.

### SUMMARY OF THE INVENTION

In view of the above-described disadvantage, it is an object of the present invention to prevent leak current generated on a terminal area and connect the terminal area with a conductive wire used for connection with an external circuit in good condition.

In order to solve the above mentioned problem and achieve the object, a fluid level sensor according to one aspect of the present invention includes a detecting element configured to detect a rotation position of an arm having a float on an end and output an electric signal corresponding to the rotation position of the arm as a fluid level signal; a lead frame configured to have a terminal area connected with a conductive wire and a base portion connected with a lead of the detecting element; and a sensor housing configured to have the terminal area of the lead frame exposed and accommodate a rest of the lead frame. The sensor housing includes a peripheral wall portion configured to form a hollow space penetrating in a depth direction of the sensor housing and be formed in a manner of surrounding a periphery of the terminal area of the lead frame; and a conductive wire inserting portion configured to be formed by notching the peripheral wall portion in the depth direction of the sensor housing so as to insert the conductive wire. The conductive wire inserting portion is configured with a first inserting portion into which the conductive wire extending from the terminal area is inserted; and a second inserting portion into which the conductive wire is inserted after passing through the first inserting portion. The conductive wire inserting portion holds the conductive wire in a manner of bending in a crank shape.

Further, in the fluid level sensor according to another aspect of the present invention, it is preferable that the second inserting portion is formed with a positional difference with respect to the first inserting portion in a lateral direction of the sensor housing orthogonal to a direction in which the conductive wire extends, forms the notch in a manner of bending in a crank shape, and arranges the bending position deeper toward a back side compared with a notch depth of the first inserting portion.

Further, in the fluid level sensor according to still another aspect of the present invention, it is preferable that the terminal area of the lead frame includes an insertion hole for inserting the conductive wire, and the first inserting portion is formed with a positional difference with respect to the insertion hole in the lateral direction of the sensor housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view that schematically illustrates a fluid level sensor according to an embodiment;

FIG. 2 is a front view that schematically illustrates a main portion of a sensor housing of the fluid level sensor;

FIG. 3 is a front view that schematically illustrates the sensor housing;

FIG. 4 is a top view that schematically illustrates the sensor housing;

FIG. 5 is an explanatory drawing that illustrates a status where a lead wire is arranged; and

FIG. 6 is another explanatory drawing that illustrates a status where the lead wire is arranged.

### DETAILED DESCRIPTION OF THE PREFERRED EMBODIMENTS

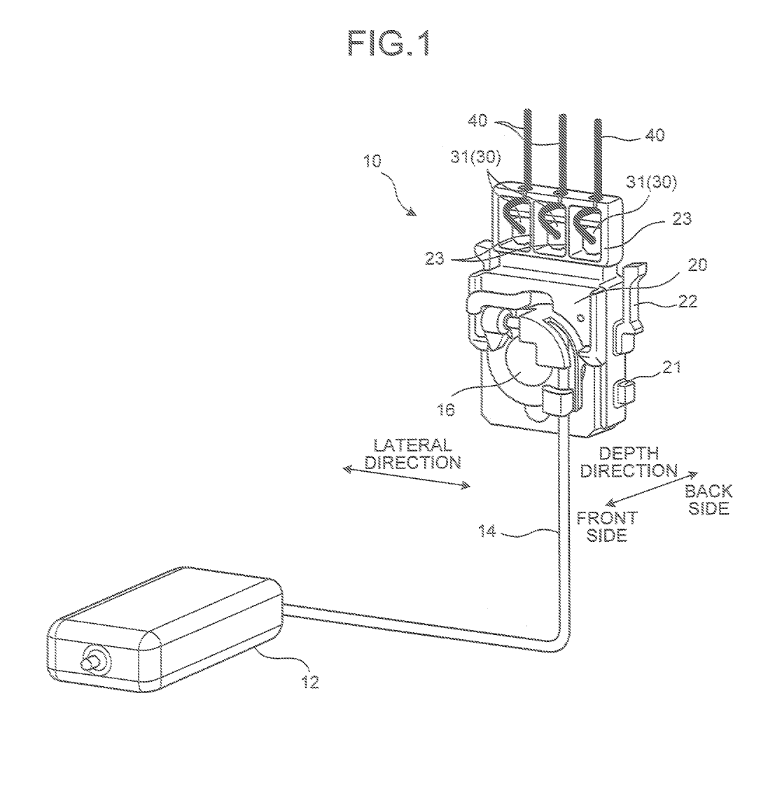

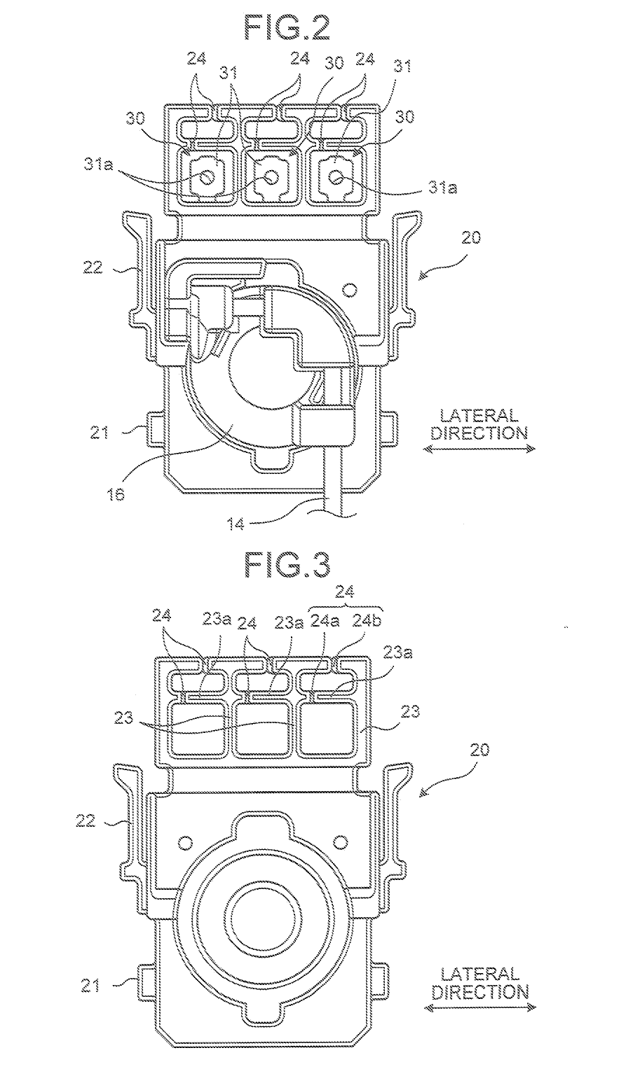

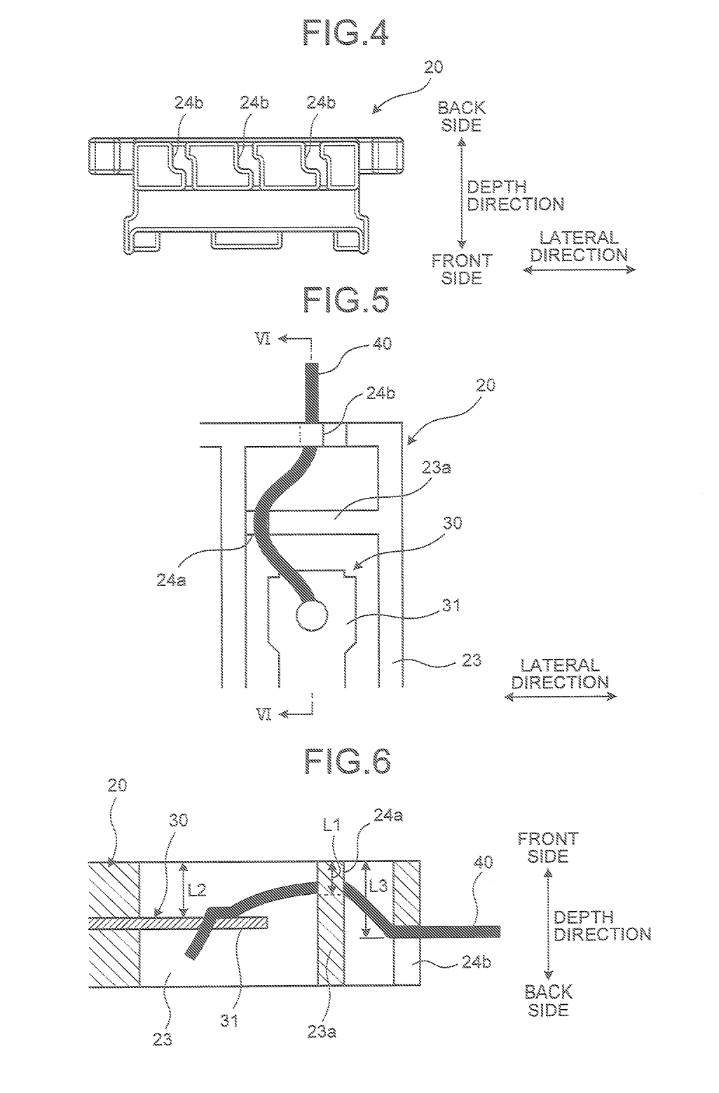

FIG. 1 is a perspective view that schematically illustrates a fluid level sensor 10 according to an embodiment. FIG. 2 is a front view that schematically illustrates a main portion of a sensor housing 20 of the fluid level sensor 10. FIG. 3 is a front view that schematically illustrates the sensor housing 20. FIG. 4 is a top view that schematically illustrates the sensor housing 20. FIGS. 5 and 6 are explanatory drawings that illustrate statuses where a lead wire 40 is arranged. FIG. 6 is a sectional view along the VI-VI line in FIG. 5. The fluid level sensor 10 is a sensor for detecting the fluid level of fuel stored in a fuel tank of a vehicle and includes a float 12, an arm 14, and the sensor housing 20.

The float 12 moves up and down with a change of the fluid level in a fuel tank. The arm 14 has one of its ends connected to the float 12 and the other end connected to a holder 16. The holder 16 is rotatably installed to a certain position of the sensor housing 20, and a ring-shaped magnet (not illustrated) is provided inside the holder 16.

The sensor housing 20 is produced by insert molding having a lead frame assembly, in which a later-described lead frame 30, a hall IC (not illustrated), and others are assembled, as an insert molded part. In the embodiment, the sensor housing 20 accommodates therein the lead frame 30 with only a terminal area 31 of the lead frame 30 exposed outside. Examples of a material used for the sensor housing 20 include polyacetal resin and polyphenylene sulfide (PPS) resin.

The hall IC is configured with a hall element serving as a detecting element, an amplifier circuit, and others. The hall IC magnetically detects a position where the arm 14 rotates and outputs an electric signal corresponding to the rotation position as a fluid level signal. Specifically, the upper and the lower positions of the float 12 vary with a change of the fluid level in a fuel tank, which rotates the holder 16 and a magnet provided thereto through the arm 14. In this process, the magnetic flux density of the magnetic field passing through the hall element varies, which consequently changes the output voltage output from the hall IC (hall element). It is thus possible to detect the rotation position of the arm 14, that is, the fluid level by detecting the fluid level signal, which is the output voltage of the hall IC.

The lead frame 30 is a circuit member made of a metal plate for electrically connecting the hall IC with an external circuit. The lead frame 30 can be formed of a metal plate made of tin-plated yellow copper, stainless steel, iron, or the like. The number of lead frames 30 corresponds to the number of leads provided to the hall IC. In the embodiment, the hall IC has three respective leads corresponding to a signal, a ground, and a power source, and three lead frames 30 are accordingly provided.

Each of the lead frames 30 is made of a plate member and has the terminal area 31 in its front end side and a base area (not illustrated) in its base end side. The terminal area 31 is connected with the lead wire 40 serving as a conductive wire and forms an insertion hole 31a for inserting a lead wire at the center portion of the terminal area 31. The base portion is connected with a lead of the hall IC.

The sensor housing 20 has a piece portion 21 and a hook portion 22, which extends in the vertical direction and capable of elastic deformation, on each of the right and left lateral surfaces. The fuel tank has a pump (not illustrated) for sending fuel outside, and the fluid level sensor 10 is installed, for example, to a pump holder of the pump. The piece portion 21 and the hook portion 22 are engaged with an engagement member provided in the pump holder side, thereby tightly fixing the fluid level sensor 10 to the pump holder.

As a feature of the embodiment, the sensor housing 20 has peripheral wall portions 23 and lead wire inserting portions 24 (conductive wire inserting portions) in its upper end portion where the terminal areas 31 of the lead frames 30 are exposed. The respective peripheral wall portions 23 and lead wire inserting portions 24 are formed in a manner of corresponding to three lead frames 30.

The peripheral wall portion 23 forms a hollow space penetrating in the depth direction of the sensor housing 20, that is, in the longitudinal direction (the direction perpendicular to the sheet in FIGS. 2 and 3) and accommodates the terminal area 31 in the hollow space. In other words, the peripheral wall portion 23 is formed in a manner of surrounding the periphery of the terminal area 31. Furthermore, in the embodiment, partition walls 23a, each of which separates a hollow space (hereinafter referred to as a “first hollow space”) including the terminal area 31 from another hollow space (hereinafter referred to as a “second hollow space”) formed in the upper position of the first follow space, are formed as a part of the peripheral wall portion 23. As FIG. 1 illustrates, “the depth direction of the sensor housing 20” generally corresponds to a direction of a center axis around which the holder 16 rotates. With regards to “the depth direction of the sensor housing 20”, a surface side to which the holder 16 is installed is referred to as a “front side” whereas the opposite side is referred to as a “back side”, in the following description.

The lead wire inserting portion 24 holds the lead wire 40 connected to the terminal area 31 in a fixed manner and is formed by notching the peripheral wall portion 23. The lead wire inserting portion 24 consists of a first inserting portion 24a and a second inserting portion 24b.

The first inserting portion 24a is a portion into which the lead wire 40 extending from the terminal area 31 is first inserted and is formed by notching the partition wall 23a of the peripheral wall portion 23 from the end surface in the front side of the depth direction toward the back side. As FIG. 6 illustrates, the notch depth of the first inserting portion 24a in the depth direction is defined as a length L1. As FIG. 6 illustrates, with the end surface of the peripheral wall portion 23 positioned in the front side of the depth direction as a reference side, when the position of the terminal area 31 in the depth direction is defined as a length L2, the notch depth L1 of the first inserting portion 24a is set smaller than the length L2 (L1<L2).

The second inserting portion 24b is a portion into which the lead wire 40 is inserted after passing through the first inserting portion 24a and is formed by notching, in the depth direction, the peripheral wall portion 23 adjacent to the partition wall 23a with the second hollow space interposed therebetween. As FIG. 4 illustrates, the second inserting portion 24b is not formed in a straight shape that simply extends in the depth direction but is formed in such a manner that bends in a crank shape by turning in the lateral direction at a middle position and again extending in the depth direction. As FIG. 6 illustrates, with the end surface of the peripheral wall portion 23 positioned in the front side of the depth direction as a reference side, when the middle position (the bending position) in the depth direction of the peripheral wall portion 23 is defined as a length L3, the length L3 is set larger than the notch depth L1 of the first inserting portion 24a (L1<L3). In other words, the second inserting portion 24b forms the notch in a manner of bending in a crank shape, and the bending position L3 is arranged in a deeper position toward the back side of the depth direction of the sensor housing 20 compared with the notch depth L1 of the first inserting portion 24a.

The first inserting portion 24a and the second inserting portion 24b are formed with a positional difference with respect to each other in the lateral direction of the sensor housing 20. Furthermore, the first inserting portion 24a is formed with a positional difference with respect to the insertion hole 31a formed on the terminal area 31 in the lateral direction of the sensor housing 20. With this configuration, the insertion hole 31a, the first inserting portion 24a, and the second inserting portion 24b are alternately arranged and exist at offset positions with respect to one another in a neighboring position. As FIG. 1 and other drawings illustrate, “the lateral direction of the sensor housing 20” generally corresponds to a direction in which a pair of lateral surfaces of the sensor housing 20, each of which has the piece portion 21 and the hook portion 22, face each other. Furthermore, “the lateral direction of the sensor housing 20” is generally orthogonal to “the depth direction of the sensor housing 20”.

With the fluid level sensor 10 in the above-described configuration, an end of the lead wire 40 is connected to the terminal area 31 of the lead frame 30, and the lead wire 40 is inserted into the lead wire inserting portion 24. The lead wire 40 is preferably made of a flexible covered electric wire in which a conductor (such as copper) serving as a core wire is covered with an insulator made from cross-linked polyethylene.

Specifically, an end of the lead wire 40 is inserted into the insertion hole 31a of the terminal area 31. The lead wire 40 is first inserted into the first inserting portion 24a and thereafter inserted into the second inserting portion 24b. In the process where the lead wire 40 is inserted into the second inserting portion 24b, the lead wire 40 is pushed to the back side of the depth direction along the shape of the second inserting portion 24b, moved in the lateral direction at the bending position, and engaged with the bending portion of the second inserting portion 24b. The terminal area 31 and an end of the lead wire 40 are connected with each other by soldering or other methods.

The lead wire 40 is configured to be connected to the terminal area 31 of the lead frame 30, to be held by the lead wire inserting portion 24, and to extend in the upward direction of the sensor housing 20 with the connecting portion with the terminal area 31 as a basing point. The other end of the lead wire 40 has a connector (not illustrated) for connecting to an external circuit. The lead frame 30 is connected with the connector (not illustrated) via the lead wire 40 connected with the terminal area 31. “The upward direction of the sensor housing 20” corresponds to a direction of the side in which the peripheral wall portion 23 is provided of the direction orthogonal to the above-described “depth direction” and “lateral direction”. “The direction in which the lead wire 40 (conductive wire) extends” corresponds to “the upward direction of the sensor housing 20”. Furthermore, “the direction in which the lead wire 40 (conductive wire) extends” is orthogonal to “the lateral direction of the sensor housing 20”.

The insertion hole 31a, the first inserting portion 24a, and the second inserting portion 24b exist at offset positions with respect to one another in a manner alternately positioned in the lateral direction of the sensor housing 20. With this configuration, the trajectory of the lead wire 40 passing through the insertion hole 31a of the terminal area 31, the first inserting portion 24a, and the second inserting portion 24b bends in a crank shape in the lateral direction as illustrated in FIG. 5. In this process, the elasticity of the lead wire 40 helps recovery of the lead wire 40 to a straight shape. The first inserting portion 24a and the second inserting portion 24b are thus engaged with the lead wire 40, and the lead wire 40 is accordingly held by the first inserting portion 24a and the second inserting portion 24b.

As described above, the notch depth L1 of the first inserting portion 24a is set smaller than the length L2, which is a position of the terminal area 31 in the depth direction, and the length L3, which is a bending position of the second inserting portion 24b in the depth direction. With this configuration, the trajectory of the lead wire 40 passing through the terminal area 31, the first inserting portion 24a, and the second inserting portion 24b bends in a crank shape in the depth direction as illustrated in FIG. 6. In this process, the elasticity of the lead wire 40 helps recovery of the lead wire 40 to a straight shape. The first inserting portion 24a and the second inserting portion 24b are thus engaged with the lead wire 40, and the lead wire 40 is accordingly held by the first inserting portion 24a and the second inserting portion 24b.

With the fluid level sensor 10 according to the embodiment, the sensor housing 20 includes the peripheral wall portions 23 and the lead wire inserting portions 24. The peripheral wall portion 23 forms a hollow space penetrating in the depth direction of the sensor housing 20 and is formed in a manner of surrounding the periphery of the terminal area 31 of the lead frame 30. The lead wire inserting portion 24 is formed by notching the peripheral wall portion 23 in the depth direction of the sensor housing 20 and includes the first inserting portion 24a, into which the lead wire 40 extending from the terminal area 31 is inserted, and the second inserting portion 24b, into which the lead wire 40 is inserted after passing through the first inserting portion 24a. The first inserting portion 24a and the second inserting portion 24b hold the lead wire 40 in a manner of bending the lead wire 40 in a crank shape.

Such a configuration that surrounds the terminal area 31 of the lead frame 30 with the peripheral wall portion 23 exerts effects of preventing leak current generated on the terminal area 31. Furthermore, according to the embodiment, parallel arrangement of a plurality of lead frames 30 effectively prevents generation of leak current between terminals.

Such a configuration that holds the lead wire 40 with the first inserting portion 24a and the second inserting portion 24b in a manner of bending the lead wire 40 in a crank shape exerts effects of appropriately holding the lead wire 40. This configuration prevents the lead wire 40 from moving when the lead wire 40 is connected to the terminal area 31, which facilitates positioning of the lead wire 40 and thus improves the installation ease. The lead wire 40 can be accordingly connected to the terminal area 31 in good condition.

Such a configuration that holds the lead wire 40 in a crank shape exerts effects of concentrating stress on the engagement point of the second inserting portion 24b and the lead wire 40 when pulling force acts on the lead wire 40, which prevents the stress from directly acting on the connection point of the lead wire 40 and the terminal area 31, which is the soldered point. The lead wire 40 can be accordingly connected to the terminal area 31 in good condition.

Because the lead wire 40 and the terminal area 31 are connected with each other by soldering, the core wire of the lead wire 40 can be covered with solder. This configuration prevents corrosion of the core wire portion caused by conductive fuel, and the lead wire 40 can be accordingly connected to the terminal area 31 in good condition.

In the embodiment, the second inserting portion 24b is formed with a positional difference with respect to the first inserting portion 24a in the lateral direction of the sensor housing 20 orthogonal to the direction in which the lead wire 40 extends. This configuration makes it possible to hold the lead wire 40 in a manner of bending in a crank shape in the lateral direction as illustrated in FIG. 5. The lead wire 40 can be thus stably held.

In the second inserting portion 24b, the notch is formed in a manner bent in a crank shape, and the bending position L3 is arranged at a deeper position toward the back side compared with the notch depth L1 of the first inserting portion 24a (L1<L3). This configuration makes it possible to hold the lead wire 40 in a manner of bending in a crank shape in the depth direction as illustrated in FIG. 6. The lead wire 40 is thus held in a multiple manner in two directions consisting of the lateral direction and the depth direction, which exerts effects of stably holding the lead wire 40.

If the notch of the second inserting portion 24b is formed in a straight shape, the lead wire 40 is likely to be disengaged in the depth direction. With the second inserting portion 24b bent in a crank shape, the lead wire 40 can be engaged to the bent portion. This configuration prevents the case that the lead wire 40 is disengaged in the back side or the front side, thereby connecting the lead wire 40 to the terminal area 31 in good condition.

In the embodiment, the terminal area 31 of the lead frame 30 has the insertion hole 31a for inserting the lead wire 40 thereinto. The first inserting portion 24a is formed with a positional difference with respect to the insertion hole 31a in the lateral direction of the sensor housing 20.

With such a configuration, the insertion hole 31a facilitates positioning in connecting the lead wire 40 to the terminal area 31. Furthermore, the insertion hole 31a, the first inserting portion 24a, and the second inserting portion 24b are alternately positioned by determining the position of the first inserting portion 24a based on the position of the insertion hole 31a. Consequently, the lead wire 40 can be connected to the terminal area 31 in good condition.

The fluid level sensor according to the embodiment has been described; however, the present invention is not limited to this embodiment, and various modifications can be made without departing from the scope of the invention. For example, in the above-described embodiment, a fluid level sensor for detecting a fuel level of a vehicle has been described; however, the present invention is not limited to vehicle application and may be used for other applications. Furthermore, in the above-described embodiment, a non-contact fluid level sensor has been described; however, the present invention is not limited to a non-contact type and may be implemented in other features such as a contact type.

According to the present invention, such a peripheral wall portion is provided so as to hold a lead wire, thereby preventing leak current generated on a terminal area and connecting the terminal area with a conductive wire used for connection with an external circuit in good condition.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fluid level sensor comprising:
a detecting element configured to detect a rotation position of an arm having a float on an end and output an electric signal corresponding to the rotation position of the arm as a fluid level signal;
a lead frame configured to have a terminal area connected with a conductive wire and a base portion connected with a lead of the detecting element; and
a sensor housing configured to have the terminal area of the lead frame exposed and accommodate a rest of the lead frame, wherein
the sensor housing includes:
a peripheral wall portion configured to form a hollow space penetrating in a depth direction of the sensor housing and be formed in a manner of surrounding a periphery of the terminal area of the lead frame; and
a conductive wire inserting portion configured to be formed by notching the peripheral wall portion in the depth direction of the sensor housing so as to insert the conductive wire, and
the conductive wire inserting portion is configured with:
a first inserting portion into which the conductive wire extending from the terminal area is inserted; and
a second inserting portion into which the conductive wire is inserted after passing through the first inserting portion, and
the conductive wire inserting portion holds the conductive wire in a manner of bending in a crank shape.

2. The fluid level sensor according to claim 1, wherein the second inserting portion is formed with a positional difference with respect to the first inserting portion in a lateral direction of the sensor housing orthogonal to a direction in which the conductive wire extends, forms the notch in a manner of bending in a crank shape, and arranges the bending position deeper toward a back side compared with a notch depth of the first inserting portion.

3. The fluid level sensor according to claim 1, wherein
the terminal area of the lead frame includes an insertion hole for inserting the conductive wire, and
the first inserting portion is formed with a positional difference with respect to the insertion hole in the lateral direction of the sensor housing.

4. The fluid level sensor according to claim 2, wherein the terminal area of the lead frame includes an insertion hole for inserting the conductive wire, and
the first inserting portion is formed with a positional difference with respect to the insertion hole in the lateral direction of the sensor housing.
